(19) United States
(12) Patent Application Publication
(10) Pub. No.: US 2025/0373015 A1
(43) Pub. Date: Dec. 4, 2025

(54) POWER DIVISION MULTIPLEXING TECHNIQUES FOR MULTI-DROP POWER DELIVERY APPLICATIONS

(71) Applicant: Cisco Technology, Inc., San Jose, CA (US)

(72) Inventors: Joel Richard Goergen, Soulsbyville, CA (US); Chad M. Jones, Doylestown, OH (US)

(21) Appl. No.: 18/676,804

(22) Filed: May 29, 2024

(51) Int. Cl. H02J 3/00; H02J 1/08

(52) U.S. Cl. CPC H02J 3/007; H02J 1/084

(57) ABSTRACT

Devices, systems and methods to provide a more effective way of allocating power across a plurality of drops in a multi-drop power delivery arrangement. A power transmitter transmits a power waveform together with a multi-drop signaling waveform. Thus, the power waveform and the multi-drop signaling waveform are directed to each of a plurality of drops. The multi-drop signaling waveform has a plurality of divisions, and each of a plurality of power receivers at respective drops of the plurality of drops are assigned to one or more divisions of the plurality of divisions of the multi-drop signaling waveform to draw an associated portion of power from the power waveform.

### TECHNICAL FIELD

The present disclosure relates to power distribution systems.

### BACKGROUND

Power consumption in multi-drop applications can be tedious and difficult to allocate.

There are many ways to deliver power in a multi-drop system, almost all of which involve software negotiation to decide how much power or what power allotment a particular powered device is granted to use.

### BRIEF DESCRIPTION OF THE DRAWINGS

FIG. 1 illustrates a block diagram of a power delivery system for delivery of power to multiple drops in a multi-drop arrangement, according to an example embodiment.

FIGS. 2A and 2B are diagrams depicting a multi-drop signaling technique that uses a multi-frequency waveform, according to an example embodiment.

FIG. 3 is a diagram depicting a multi-drop signaling technique that uses a single frequency waveform, according to an example embodiment.

FIG. 4 is a diagram depicting a percentage of power allocation technique, according to an example embodiment.

FIG. 5 is a flow chart depicting a process to negotiate power type and assignment of divisions of a multi-drop signaling waveform to a plurality of drops in a multi-drop power delivery arrangement, according to an example embodiment.

FIG. 6 is a block diagram of a power transmitter subsystem configured to perform the power transmitter side techniques presented herein, according to an example embodiment.

FIG. 7 is a block diagram of a power receiver subsystem configured to perform the power receiver side techniques presented herein, according to an example embodiment.

FIG. 8A is a block diagram of a power transmitter configured to provide a power waveform and a multi-drop signaling waveform, as well as to perform fault managed power techniques, according to an example embodiment.

FIG. 8B is a block diagram of a power receiver configured to receive a power waveform and a multi-drop signaling waveform and to draw power from the power waveform according to an assigned division of the multi-drop signaling waveform, as well as to perform fault managed power techniques, according to an example embodiment.

FIG. 8C is a block diagram of a power delivery system that includes a power transmitter and a power receiver, each configured with a digital fuse, according to still another fault managed power variation, as well as to participate in the multi-drop power delivery arrangements presented herein, according to an example embodiment.

FIG. 9 is a flow chart depicting operations performed by a power transmitter for delivery of power to multiple drops in a multi-drop arrangement, according to an example embodiment.

FIG. 10 is a flow chart depicting operations performed by a power receiver for drawing power from a power waveform at a particular drop of a plurality of drops, according to an example embodiment.

FIG. 11A is a block diagram of a power transmitter configured to modulate a power waveform with a chirp waveform to produce a modulated power waveform, according to an example embodiment.

FIG. 11B is a diagram depicting an example of a chirp waveform and a modulated power waveform derived from the chirp waveform, according to an example embodiment.

FIG. 12A is a block diagram of a system that employs a modulated power waveform, according to an example embodiment.

FIG. 12B is a diagram of a chirp waveform in which frequencies of the chirp waveform are allocated to transmit power bi-directionally, according to an example embodiment.

FIG. 12C is a diagram of a modulated power waveform in which frequencies are allocated to transmit power bi-directionally, according to an example embodiment.

FIG. 13 is a flow chart depicting a method for modulating a power waveform according to an example embodiment.

FIG. 14 is a block diagram of a device that may be configured to perform operations on behalf of any of the various entities forming a part of the power delivery system presented herein, according to an example embodiment.

### DETAILED DESCRIPTION

### Overview

In one aspect, a method is provided that is performed by a power transmitter. The method includes generating a multi-drop signaling waveform having a plurality of divisions. One or more divisions of the plurality of divisions are assigned to a corresponding drop of a plurality of drops in a multi-drop power delivery arrangement. The method further includes transmitting a power waveform together with the multi-drop signaling waveform into the multi-drop power delivery arrangement such that a power receiver at each drop of the plurality of drops draws an associated portion of power from the power waveform based on assignment of one or more divisions to a respective drop of the plurality of drops.

In addition, in another aspect, a method is provided that is performed by a power receiver. The method includes, at a drop of a plurality of drop in a multi-drop power delivery arrangement, receiving a power waveform together with a multi-drop signaling waveform having a plurality of divisions. The method further includes identifying one or more assigned divisions to the drop in the multi-drop signaling waveform. The method still further includes, based on the identifying, drawing power from the power waveform for the one or more assigned divisions for the drop.

In still another aspect, a method is provided that involves obtaining a power waveform, and at a first device, modulating the power waveform with a chirp waveform comprising a sequence of frequencies to produce a modulated power waveform for transmission over a cable to a second device.

In yet another aspect, a system is provided comprising a plurality of power receivers at a corresponding drop of a plurality of drops in multi-drop arrangement; and a power transmitter. The power transmitter is configured to generate a multi-drop signaling waveform having a plurality of divisions, one or more divisions of the plurality of divisions to be assigned to a corresponding drop of the plurality of drops; and superimpose or modulate the multi-drop signaling waveform onto a power waveform to produce a modulated power waveform for transmission into the multi-drop arrangement such that the power receiver at each drop draws an associated portion of power from the power waveform based on assignment of one or more divisions to a respective drop of the plurality of drops.

### Example Embodiments

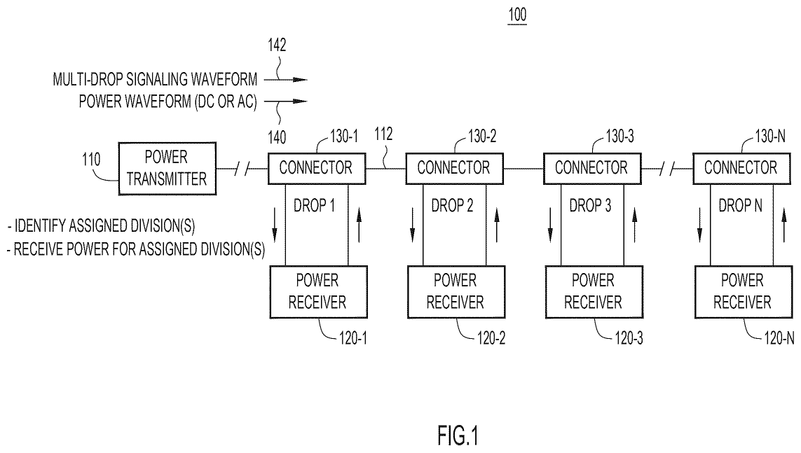

Presented herein are devices, systems and methods to provide a more effective way of allocating power across a plurality of drops in a multi-drop power delivery arrangement. FIG. 1 illustrates a block diagram of a system 100 according to an example embodiment. The system 100 includes a power transmitter 110 and a plurality of power receivers 120-1, 120-2, 120-3 to 120-N. The power transmitter 110 transmits power over a cable 112, and there are connectors 130-1, 130-2, 130-3, to 130-N to the cable 112, one of the connectors 130-1 to 130-N for each drop point to a corresponding power receiver of the plurality of power receivers 120-1 to 120-N. In one example, the connectors 130-1 to 130-N are, for example, ARJ45® connectors.

The power transmitter 110 transmits a modulated power waveform 140 based on a multi-drop signaling waveform 142 onto the cable 112. Thus, a modulated power waveform 140 is are directed by each of the connectors 130-1 to 130-N to its associated power receiver. As explained in more detail below, the multi-drop signaling waveform 142 has a plurality of divisions, and each of the plurality of power receivers at respective drops are assigned to one or more divisions of the plurality of divisions of the multi-drop signaling waveform 142 to draw an associated portion of power from the power waveform 140. In other words, each power receiver detects the multi-drop signaling waveform 142, that is modulated/superimposed on a power waveform, to identify the one or divisions of the multi-drop signaling waveform 142 assigned to it. Based on the occurrence of the one or more divisions of the multi-drop signaling waveform 142 assigned to the power receiver, the power receiver draws power from the modulated power waveform 140 for a time duration corresponding to the one or more assigned divisions. The power transmitter 110 may be one component of a larger device or subsystem referred to herein as a power transmitter subsystem. Likewise, each power receiver may be one component of a larger device or subsystem referred to herein as a power receiver subsystem.

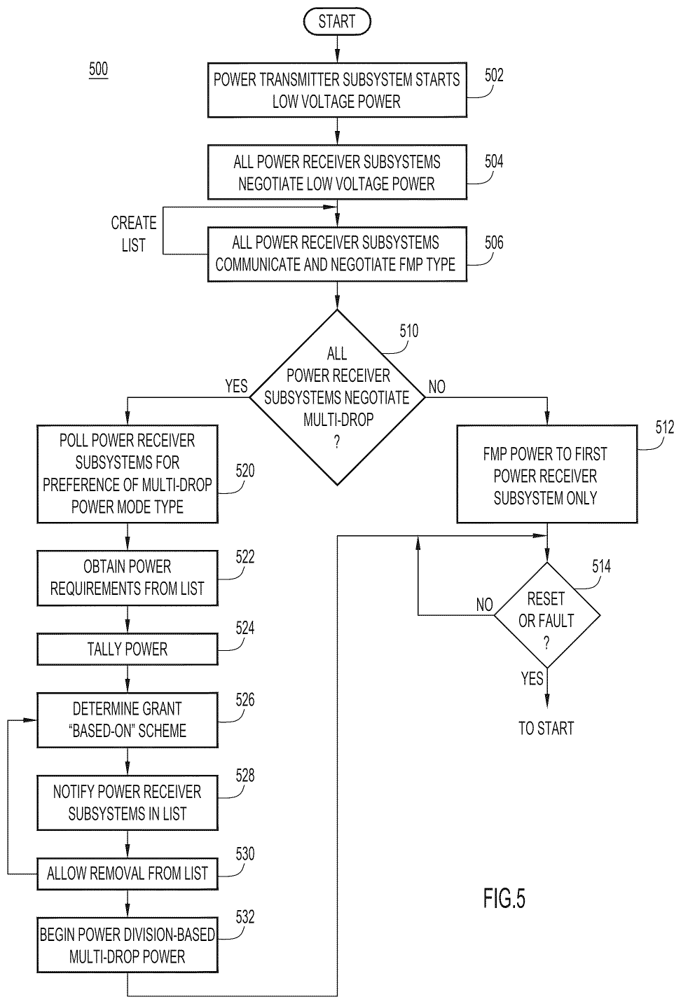

Techniques are described below in connection with FIG. 5 that explain how power receiver subsystems may negotiate and be assigned certain divisions of the multi-drop signaling waveform 142.

The power may be a direct current (DC) power waveform or an alternating current (AC) power waveform, and the multi-drop signaling waveform is used to modulate the power waveform so as to produce a modulated power waveform.

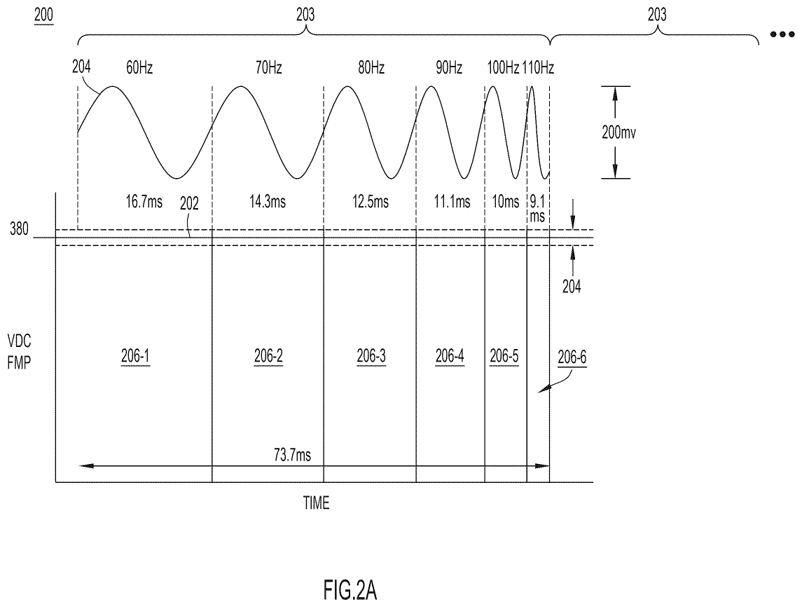

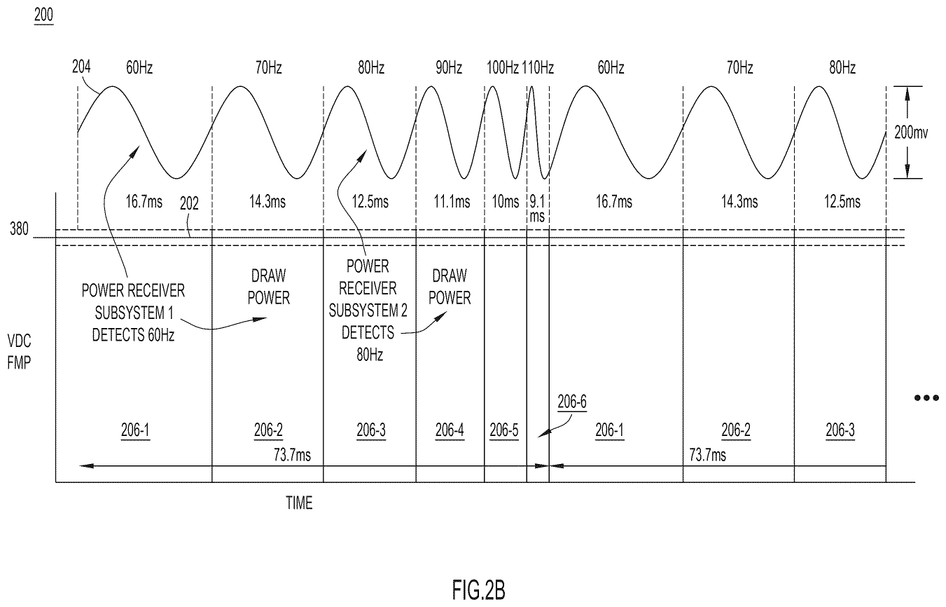

Reference is now made to FIGS. 2A and 2B which shows a multi-drop signaling arrangement 200 according to an example embodiment. These figures illustrate an example embodiment in which the multi-drop signaling waveform is used to modulate a power waveform to produce a modulated power waveform. The multi-drop signaling waveform comprises a sequence of a plurality of frequencies that extend for a corresponding time period, and a plurality of divisions of the multi-drop signaling waveform are the plurality of frequencies of the multi-frequency waveform. Thus, in this embodiment a frequency component is used to divide and signal the power drawing periods for the different drops, that is, when and how a power receiver subsystem may draw power from the modulated power waveform. This is analogous to orthogonal frequency division multiplexing (OFDM), but uses frequency to dictate how devices draw power from an accompanied power waveform, and is thus referred to herein as orthogonal frequency power division multiplexing (OFPDM). A power transmitter subsystem (that includes a power transmitter) is configured to transmit the multi-drop signaling waveform and the power waveform.

For example, in FIG. 2A a power waveform 202 is shown, such as a 380 VDC power waveform. A multi-drop signaling waveform 204 is superimposed or modulated on the power waveform 202 to produce a modulated power waveform. In the example of FIG. 2A, the multi-drop signaling waveform 204 comprises a sinusoidal waveform having a sequence 203 that comprises a plurality of frequencies: 60 Hz, 70 Hz, 80 Hz, 90 Hz, 100 Hz, and 110 Hz. Each of the plurality of frequencies of the multi-drop signaling waveform 204 may extend for a full cycle at that frequency, and thus has a corresponding time period or duration. These time periods 206-1, 206-2, 206-3, 206-4, 206-5 and 206-6, respectively, are progressively shorter with increasing frequency. That is, the multi-drop signaling waveform 204 has a first frequency of 60 Hz, for a full cycle, that consequently lasts a first time period 206-1 of 16.7 milliseconds (ms); a second frequency of 70 Hz, for a full cycle, that lasts a second time period 206-2 of 14.3 ms, a third frequency of 80 Hz that lasts a third time period 206-3 of 12.5 ms, a fourth frequency of 90 Hz that lasts a fourth time period 206-4 of 11.1 ms, a fifth frequency of 100 Hz that lasts a fifth time period 206-5 of 10 ms, and a six frequency of 110 Hz that last as sixth time period 206-6 of 9.1 ms. In this example, the overall duration of all six frequencies is 73.7 ms, and the peak-to-peak magnitude of the waveform may be, for example, 200 mV. The multi-drop signaling waveform 204 may then repeat at the end of that overall duration. Thus, multi-drop signaling waveform 204 has six time divisions each of which can be identified by a power receiver subsystem based on a corresponding frequency of the waveform during that time division. The sequence 203 repeats over time. Moreover, the frequencies could be arranged in descending order instead of ascending order as shown in FIG. 2A. The multi-drop signaling waveform 204 may be referred to as a “chirp pulse” or “chirp waveform” and as still a further variation, the same frequency may occur more than once within the sequence of frequencies.

FIG. 2B shows how the multi-drop signaling waveform 204 may be used to signal to a power receiver subsystem when to draw power from the power waveform 202. Each of a plurality of powered devices are assigned to one or more frequencies of the multi-drop signaling waveform 204. A first power receiver subsystem (Power Receiver Subsystem 1) in a multi-drop power delivery arrangement that is assigned to 60 Hz detects the 60 Hz portion of the multi-drop signaling waveform that has been modulated onto the power waveform, the first power receiver subsystem is configured to draw power from the power waveform 202 during the next cycle of the multi-drop signaling waveform 204 (that has been modulated onto the power waveform), that is, during the 70 Hz cycle portion of the multi-drop signaling waveform 204, that lasts for 14.3 ms (from rising zero-crossing to rising zero-crossing). Similarly, a second power receiver subsystem (Power Receiver Subsystem 2) in the multi-drop power delivery arrangement is assigned to 80 Hz and is configured to draw power at the next cycle of the multi-drop signaling waveform 204, that is, during the 90 Hz portion of the multi-drop signaling waveform 204. Though not shown in FIG. 2B, a third power receiver subsystem may be assigned to 100 Hz and thus detects the 100 Hz portion of the waveform and draws power during the 110 Hz portion of the multi-drop signaling waveform. Still another power receiver subsystem may be assigned to 110 Hz and thus detects the 110 Hz portion of the waveform and draws power during the 60 Hz portion of the multi-drop signaling waveform (back to the beginning of the sequence of frequencies of the multi-drop signaling waveform 204). Thus, there are up to 6 possible divisions of the multi-drop signaling waveform 204 that can be assigned to power receivers (drops). A given power receiver (drop) can be assigned more than one division, which effectively allocates even more power to that power receiver (drop).

The assignment of power receivers (drops) to frequencies of the multi-drop signaling waveform 204 may be determined through a negotiation process, an example of which his described below in connection with FIG. 5. Power receivers negotiate which pulse identifier to use and allocate the associated power drawing period.

The multi-frequency multi-drop signaling waveform 204 can achieve fast time slots for current draw, and involve less of a hold up capacitor value given the speed of the duty cycle and or response of the duty cycle. A power receiver may draw power from one or more time period divisions of the multi-drop signaling waveform 204 as long as the power receiver negotiated that, or if another power receiver gives up its time period division allocation.

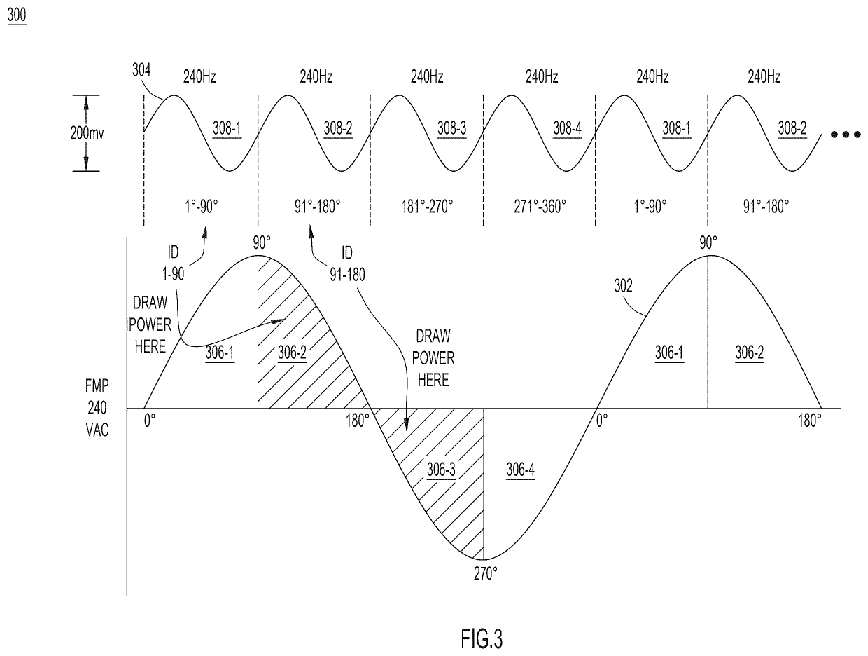

Reference is now made to FIG. 3, which shows a diagram depicting a multi-drop arrangement 300 for an AC power waveform 302, according to an example embodiment. In this embodiment, the multi-drop signaling waveform 304 comprises a waveform, e.g., a sinusoidal waveform, of a predetermined frequency. For example, the AC power waveform 302 is a 60 Hz, 240 V, waveform and the multi-drop signaling waveform 304 is a 240 Hz waveform (of 200 mV) that is modulated onto the AC power waveform 302. Each cycle of the multi-drop signaling waveform 304 is assigned to a different phase division of the AC power waveform 302. In the example of FIG. 3, the AC power waveform 302 is divided into four time periods each associated with one of four 90 degree phase divisions 306-1, 306-2, 306-3 and 306-4. A drop is assigned to a cycle of the multi-drop signaling waveform 304, and each cycle of the multi-drop signaling waveform 304 is in turn is assigned to one of the four phase divisions 306-1, 306-2, 306-3 and 306-4. For example, cycle 308-1 (from rising zero-crossing to rising zero-crossing) is assigned to the 1-90 degree phase division 306-1 which signals to a power receiver subsystem (drop) assigned to cycle 308-1 that it should draw power for a time period corresponding to the next 90 degrees phase division 306-2. Similarly, cycle 308-2 of the multi-drop signaling waveform 304 signals to a power receiver subsystem (drop) assigned to cycle 308-2 that it should draw power for a time period corresponding to the next 90 degrees phase division 306-3. This continues for other phase divisions of the AC power waveform 302 for cycles 308-3 and 308-4. If it is desired to further divide the AC power waveform 302 into 8 phase divisions (each of 45 degrees), then the multi-drop signaling waveform 304 should be a 480 Hz waveform. Moreover, a power receiver subsystem may draw power from several phase divisions of the modulated AC power waveform (by assignment to several corresponding cycles of the multi-drop signaling waveform). Thus, to generalize the concepts depicted in FIG. 3, the multi-drop signaling waveform is a waveform of a predetermined frequency, and each cycle of a plurality of cycles of the waveform is a division of the plurality of divisions and are associated with one of a plurality of phase divisions of the power waveform. Moreover, each drop of the plurality of drops is assigned to one or more cycles of the plurality of cycles of the waveform, and a power receiver draws power from the modulated power waveform during a time period corresponding to a next subsequent cycle of the plurality of cycles of the waveform to a cycle to which the drop is assigned.

While FIGS. 2A, 2B and 3 show ways to divide a voltage power waveform, it should be understood that these techniques can be applied to current.

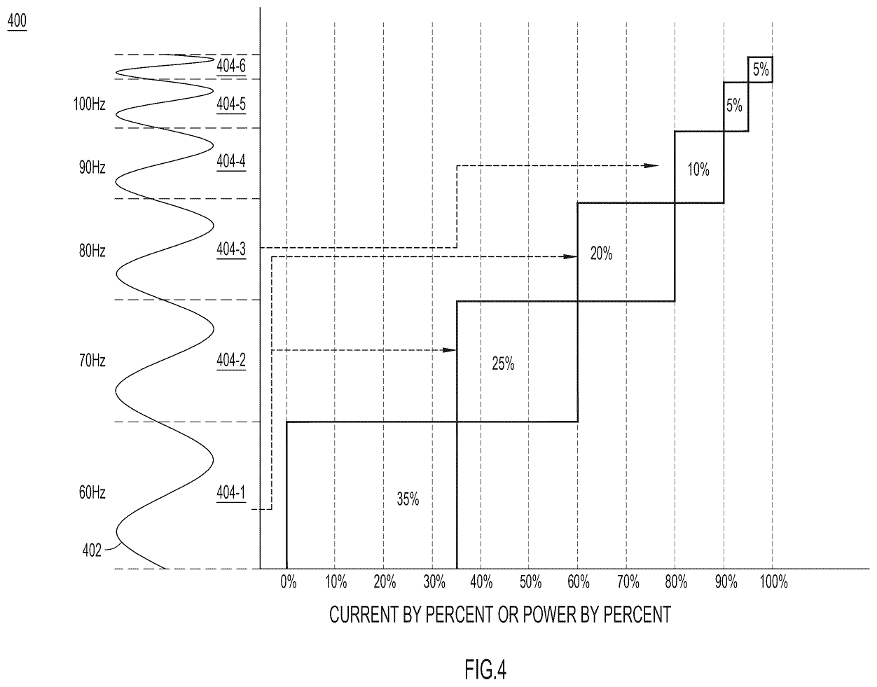

Turning now to FIG. 4, a diagram is shown for still another multi-drop power delivery arrangement 400. The techniques depicted in FIGS. 2A, 2B and 3 involve a hold-up time to allow a power receiver subsystem at a drop to wait until a next time period when it is permitted to draw power from a modulated power waveform. The multi-drop power delivery arrangement 400 of FIG. 4 involves a percentage of current or power allocation. In the example of FIG. 4, there is a multi-drop signaling waveform 402 that comprises a plurality of different frequencies at different cycles of the waveform, such as 60 Hz for a first cycle at 404-1, 70 Hz for a second cycle at 404-2, 80 Hz for a third cycle at 404-3, 90 Hz at a fourth cycle at 404-4, 100 Hz at a fifth cycle at 404-5 and 110 Hz at a sixth cycle at 404-6. The corresponding time period for each of the different frequencies of the multi-drop signaling waveform 402 may be associated with a corresponding percentage allocation of power (or of current) of a modulated power waveform. For example, a power receiver subsystem assigned to 60 Hz would get to draw 25% of the modulated power waveform, a power receiver subsystem assigned to 70 Hz would get to draw 20% of the modulated power waveform, a power receiver subsystem assigned to 80 Hz would get to draw 10% of the modulated power waveform, and so on. The power receiver subsystem assigned to 110 Hz would get to the draw 35% of the modulated power waveform.

Reference is now made to FIG. 5, for a description of a negotiation process 500 by which power receiver subsystem may negotiate (on behalf of a device to be powered) a portion of a modulated power waveform, and thus assignment of the corresponding frequency (or frequencies) of the multi-frequency signaling waveform of FIGS. 2A and 2B or the corresponding cycle (or cycles) of the signaling waveform of FIG. 2B. The process 500 is performed at a power transmitter subsystem that is configured to transmit power into a multi-drop power delivery arrangement.

At step 502, the power transmitter subsystem starts low voltage power. This may be at a level similar to, or the same as, Power-over-Ethernet (POE) power. At step 504, all of the power receiver subsystems negotiate low voltage power.

Next, at step 506, all of the power receiver subsystems communicate with the power transmitter subsystem and negotiate the type of fault managed power (FMP) desired, such as FMP 240 VDC, FMP 380 VDC, FMP 48 VDC, FMP AC power, etc. The power transmitter subsystem creates a device list that specifies the power receiver subsystems and the type of power each power receiver subsystem requests.

At step 510, the power transmitter determines whether or not all the power receiver subsystems wish to negotiate multi-drop power. This may be determined based on information received during step 506 or via a separate request made by each of the power receiver subsystems during this step.

If all of the power receiver subsystems do not negotiate multi-drop, then the process 500 goes to step 512 in which FMP power is provided only to the first powered device in the chain. Then, at step 514, a reset or fault determination is made after FMP power is being provided to the first power receiver subsystem, and if such a reset of fault condition is detected, then the process restarts at step 502; otherwise, FMP power continues to be provided until and if such a condition is detected.

If, at step 510, a determination is made that all the power receiver subsystems do wish to negotiate multi-drop power delivery, then at step 520, the power transmitter subsystem polls the power receiver subsystems for preference of multi-drop power mode type. For example, the multi-drop power mode type could be OFDPM voltage mode (a voltage power waveform allocated across multiple drops using a multi-frequency waveform such as that shown in FIGS. 2A and 2B), OFDPM current mode (a current power waveform allocated across multiple drops using a multi-frequency waveform such as that shown in FIGS. 2A and 2B), or an AC power mode that uses a single frequency waveform to allocate phase divisions of an AC power waveform to multiple drops as depicted in FIG. 3.

After the power receiver subsystems have responded regarding the multi-drop power mode type, at step 522, the power transmitter subsystem polls the power receiver subsystems to obtain the power requirements from the list that was created at step 506. In step 524, the power transmitter subsystem then tallies the power requirements across the power receiver subsystems.

At step 526, the power transmitter subsystem determines a grant “based-on” scheme for allocating power across the power receiver subsystems. For example, the power transmitter subsystem may grant power in any of the following ways: (1) across the power receiver subsystems from the least/lowest power requirement power receiver subsystem to the most/greatest power requirement power receiver subsystem, until all the power of the power waveform is allocated; (2) across the power receiver subsystems from the most/greatest power requirement power receiver subsystem to the least/lowest power requirement power receiver subsystem, until all the power of the power waveform is allocated; (3) randomly across the power receiver subsystems until all the power of the power waveform is allocated; (4) according to an administrative user assigned list order. Other grant schemes are envisioned as well.

At step 528, the power transmitter subsystem notifies the power receiver subsystems in the list as to the assignment of the signaling waveform (one or more frequencies of a multi-frequency signaling waveform for the scheme of FIGS. 2A and 2B or one or more cycles of a fixed frequency signaling waveform for the scheme of FIG. 3). This allows each power receiver subsystem to know which portion of the signaling waveform to look for, and thus, from which portion(s) of the power waveform to draw power.

At step 530, the power transmitter subsystem allows a power receiver subsystem to remove itself from the list of power receiver subsystems to receive multi-drop power. If a power receiver subsystem does that, then the grant scheme is performed again, without that power receiver subsystem, in step 526, as shown in FIG. 5.

At step 532, the power transmitter subsystem begins providing power division-based multi-drop power by transmitting a modulated power waveform (produced by modulating a power waveform with the multi-drop signaling waveform) according to the multi-drop power mode type determined in step 520 and the grant scheme determined in step 526.

While the multi-drop power is being delivered, if a reset condition or fault condition is detected or determined, then the process reverts to step 502; otherwise, the power transmitter subsystem continues to deliver power.

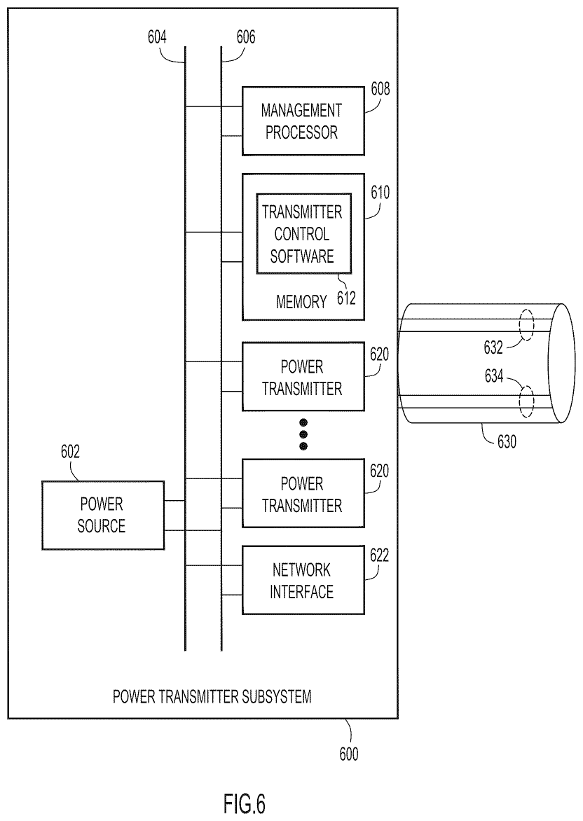

Reference is now made to FIG. 6, which illustrates a block diagram of a power transmitter subsystem 600 that may be configured to perform the operations described herein. The power transmitter subsystem 600 includes a power source 602 (AC, DC, renewable, battery, etc.) (or multiple such power sources of different types), a power bus 604, a communication bus 606, a management processor 608, memory 610 that stores instructions for transmitter control software 612, one or more power transmitters 620 and a (wired and/or wireless) network interface 622. The management processor 608 may be a microprocessor or microcontroller configured to execute various instructions, including the transmitter control software 612, to perform the power transmitter subsystem operations described herein, including selecting the appropriate multi-drop signaling waveform as part of the negotiation process of FIG. 5, storing information indicating assignments of power receiver subsystems to divisions of the multi-drop signaling waveform that are associated with power divisions of the power waveform according to the negotiation process shown in FIG. 5, and other various functions of the power transmitter subsystem related to the multi-drop power delivery techniques presented herein. The power transmitter(s) 620 is configured to provide an AC power waveform or a DC power waveform, as well as to superimpose or modulate a multi-drop signaling waveform on the AC power waveform or DC power waveform. Moreover, the power transmitter(s) 620 may be configured to perform fault managed power (FMP) techniques to interrupt power upon detection of a fault in the system. The network interface 622 enables network communication on behalf of the power transmitter subsystem. The power transmitter subsystem 600 transmits power and data over cable 630 that contains at least one wire pair 632 for power and at least one wire pair 634 for data.

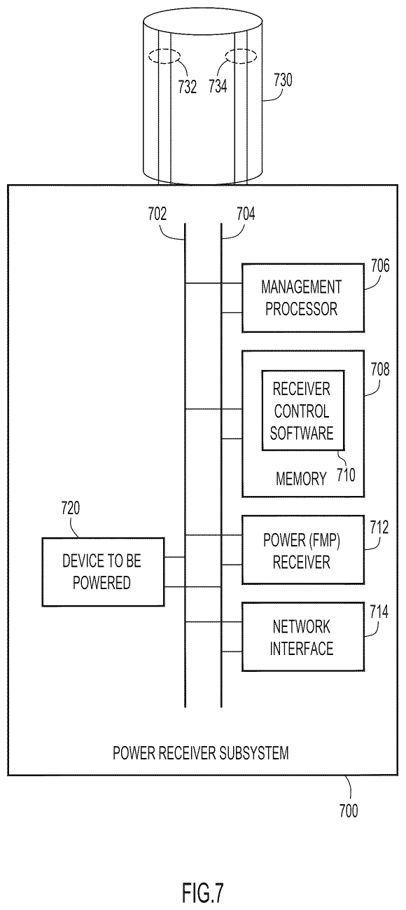

FIG. 7 illustrates a block diagram of a power receiver subsystem 700 that may be configured to perform the operations described herein. The power receiver subsystem 700 includes a power bus 702, a communication bus 704, a management processor 706, memory 708, receiver control software 710 stored in the memory 708, a power receiver 712, a (wired and/or wireless) network interface 714, and a device 720 to be powered (sometimes referred to as a powered device). The management processor 706 may be a microprocessor or microcontroller configured to execute various instructions, including the receiver control software 710, to perform the power receiver subsystem operations described herein, including receiver side operations as part of the negotiation process depicted in FIG. 5, control of power draw during assigned time division period of the modulated power waveform, and other various functions of the power receiver subsystem related to the multi-drop power delivery techniques presented herein. The power receiver 712 is configured to detect the assigned division(s) of the multi-drop signaling waveform modulated on the power waveform so as to control when to draw power from the modulated power waveform. Moreover, the power receiver 712 may be configured to perform fault managed power (FMP) techniques to interrupt power upon detection of a fault in the system. The network interface 714 enables network communication on behalf of the power receiver subsystem. The power receiver subsystem 700 receives power and data over cable 730 that contains at least one wire pair 732 for power and at least one wire pair 734 for data.

The term “Fault Managed Power (FMP)” as used herein may refer to power (e.g., >100 W), high voltage (e.g., >56V) delivered on one or more wires or wire pairs in such a way to allow for the power over the one or more wires or wire pairs to be terminated upon detection of a fault condition on the wire that could be harmful to a human, for example. In one example, power and data may be transmitted together (in-band) on at least one wire pair. FMP may involve fault detection (e.g., fault detection (safety testing) at an initialization stage, and thereafter on an ongoing basis during power delivery. The power may be, but is not required to be, pulse power comprising high power pulses separated by off times, and fault detection may be performed during the off times. The power may be transmitted with communications (e.g., bi-directional communications) or without communications.

The term “pulse power” (also referred to as “pulsed power”) refers to power that is delivered in a sequence of pulses (alternating low direct current voltage state and high direct current voltage state) in which the voltage varies between a very small voltage (e.g., close to 0V, 3V) during a pulse-off interval and a larger voltage (e.g., >12V, >24V) during a pulse-on interval. High voltage pulse power (e.g., >56 VDC, >60 VDC, >300 VDC, ˜108 VDC, ˜380 VDC) may be transmitted from power sourcing equipment to a powered device for use in powering the powered device. Pulse power transmission may be through cables, transmission lines, bus bars, backplanes, PCBs (Printed Circuit Boards), and power distribution systems, for example. It is to be understood that the power and voltage levels described herein are only examples and other levels may be used.

As noted above, safety testing (fault sensing) may be performed through a low voltage safety check between high voltage pulses in the pulse power system. Fault sensing may include, for example, line-to-line fault detection with low voltage sensing of the cable or components and line-to-ground fault detection with midpoint grounding. The time between high voltage pulses may be used, for example, for line-to-line resistance testing for faults and the pulse width may be proportional to DC (Direct Current) line-to-line voltage to provide touch-safe fault protection. The testing (fault detection, fault protection, fault sensing, touch-safe protection) may comprise auto-negotiation between power components. The high voltage DC pulse power may be used with a pulse-to-pulse decision for touch-safe line-to-line fault interrogation between pulses for personal safety.

In one or more embodiments, FMP may comprise power (such as, but not limited to, pulse power) transmitted in multiple phases in a multi-phase power system with pulses offset from one another between wires or wire pairs to provide continuous power. One or more embodiments may, for example, use multi-phase power to achieve less loss, with continuous uninterrupted power with overlapping phase pulses.

The power transmitter described herein may supply any of a variety of types of power, including 380 VDC, 380 VDC fault managed power (FMP), 48 VDC, 240 volts AC (VAC), 120 VAC, 480/277 VAC, Power over Ethernet (POE), 24 VAC control, and up to, and exceeding, 1000 VDC and 750 VAC. The 380 VDC FMP refers to pulse power delivered in a series of pulses of power spaced by off periods, and during the off periods fault detection techniques may be performed.

Power, such as FMP, may be converted into Power over Ethernet (POE) and used to power electrical components. In one or more embodiments, power may be supplied using Single Pair Ethernet (SPE) and may include data communications (e.g., 1-10GE (Gigabit Ethernet)). The power system may be configured for PoE (e.g., conventional PoE or PoE+ at a power level <100 watts (W), at a voltage level <57 volts (V), according to IEEE 802.3af, IEEE 802.3at, or IEEE 802.3bt), Power over Fiber (PoF), advanced power over data, FMP, or any other power over communications system in accordance with current or future standards, which may be used to pass electrical power along with data to allow a single cable to provide both data connectivity and electrical power to components (e.g., battery charging components, server data components, electric vehicle components). To be clear, FMP may involve pulse power or continuous non-interrupted power.

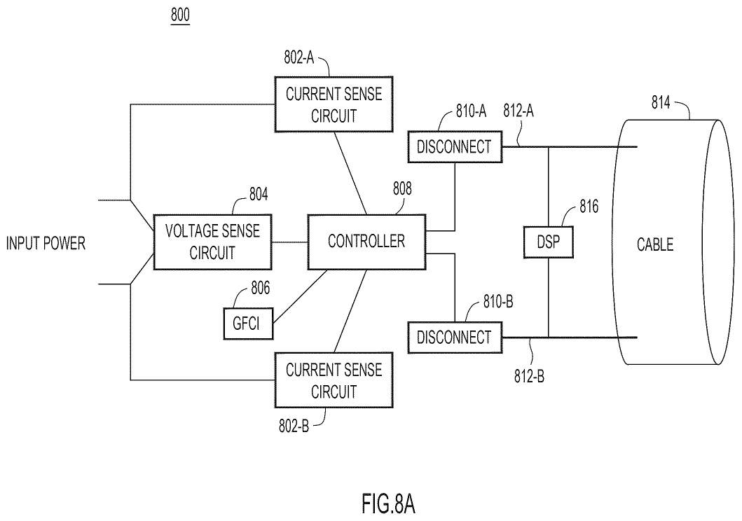

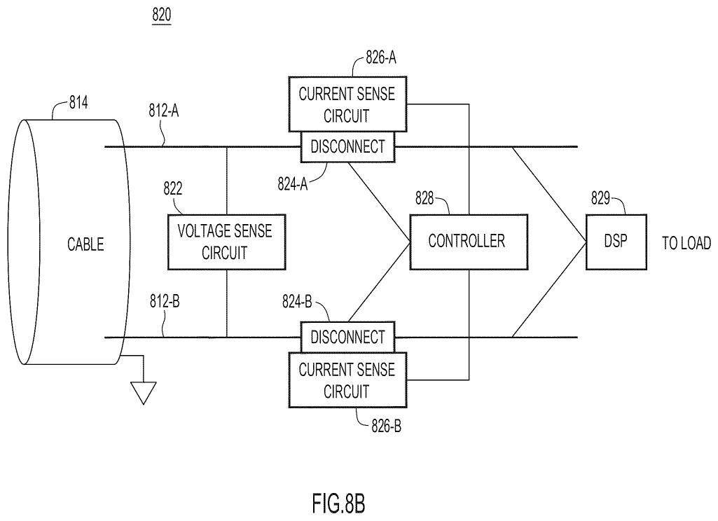

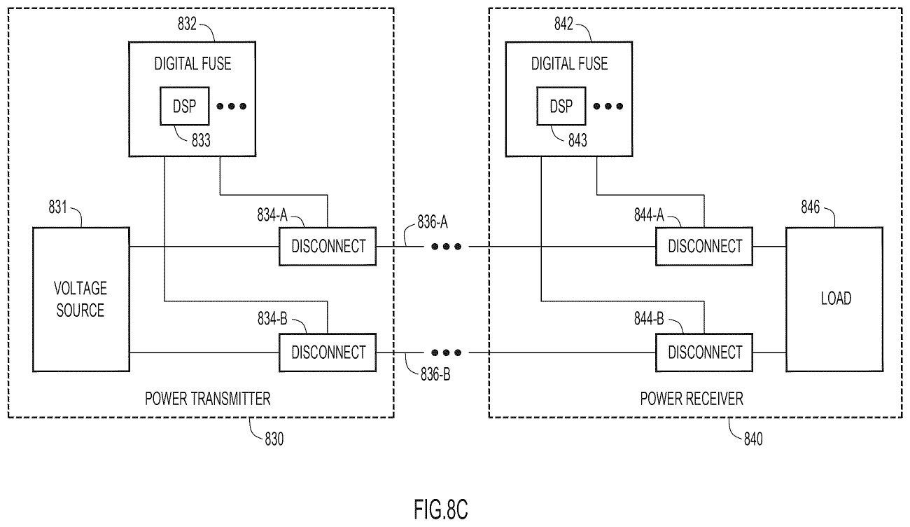

FIG. 8A illustrates a block diagram of a power transmitter 800 (which may be referred to as a power sourcing equipment) configured to perform and participate in the techniques presented herein. The block diagram of the power transmitter 800 shown in FIG. 8A may be suitable for the power transmitter 110 shown in FIG. 1. The power transmitter 800 may include two current sense circuits (current sensors) 802-A and 802-B, a voltage sense circuit (voltage sensor) 804, a ground fault circuit interrupter (GFCI) 806, a controller 808 and two disconnects 810-A and 810-B. The GFCI 806 can operate any time (even when power is being delivered onto lines 812-A and 812-B) because it looks for mismatches as to what current is sent on one line and what current comes back on the other line.

The current sense circuits 802-A and 802-B are associated with respective lines of a loop and are coupled to the disconnects 810-A and 810-B, respectively, which are in turn connected to lines 812-A and 812-B that may be contained within a cable 814.

Power is input onto two current paths. Each of these current paths traverses a current sensor, e.g., current sense circuit 802-A and 802-B, and their relative voltage is measured by the voltage sense circuit 804. The controller 808 receives the measurements from the current sense circuits 802-A and 802-B and the voltage sense circuit 804. The controller 808 may also be responsive to the GFCI 806 during power delivery time periods for added safety. The current sense circuits 802-A and 802-B measure current and passes these values to the controller 808. The current then flows to disconnect 810-A onto line 812-A into the cable 814 (to the power receiver) and comes back on the return current path on line 812-B into disconnect 810-B.

The controller 808 actuates at least one of the disconnects 810-A and 810-B to isolate power source current from the lines 812-A and 812-B (forming a current loop when connected at opposite ends to a power receiver) in the event safety criteria is not met according to the evaluation by the controller 808 of the line conditions (line-to-line fault detection, a line-to-ground fault as detected by the GFCI 806, or other current or voltage conditions detected by the controller 808). The disconnects 810-A and 810-B may be relays or switches, such as field effect transistor (FET) switches, and in some embodiments, back-to-back FETs. The controller 808 may be a microprocessor, microcontroller, digital signal processor (DSP), or other digital logic device (with fixed or programmable digital logic gates) configured to perform the techniques described herein.

In one embodiment, an additional DSP 816 may be provided to generate the multi-drop signaling waveform that is used to modulate a power waveform to be applied to the lines 812-A and 812-B. The DSP 816 may also modulate the power waveform (voltage or current, AC or DC) with the multi-drop signaling waveform to produce the modulated power waveform that is applied to the lines 812-A and 812-B. Alternatively, the controller 808 may be configured to generate one the multi-drop signaling waveform, and to modulate the power waveform with the multi-drop signaling waveform.

FIG. 8B is a block diagram of a power receiver 820 that is coupled to a cable, e.g., cable 814, containing lines 812-A and 812-B from the power transmitter shown in FIG. 8A, as an example. The power receiver 820 may be representative of the power receivers 120-1 to 120-N shown in FIG. 1. The power receiver 820 includes a voltage sense circuit 822, disconnects 824-A and 824-B that are connected to lines 812-A and 812-B, respectively, current sense circuits 826-A and 826-B connected to sense current on lines 812-A and 812-B, respectively, and a controller 828. As explained above, the lines 812-A and 812-B form a current loop between a power transmitter and the power receiver 820.

The power receiver 820 receives power (the aforementioned modulated power waveform) on lines 812-A and 812-B of the cable 814 as input, with an optional ground reference. The voltage sense circuit 822 makes a voltage measurement on the incoming power for telemetry, loop resistance calculation, or any other reason associated with the techniques presented herein. This current path then traverses disconnects 824-A and 824-B as well as current sense circuits 826-A and 826-B on the respective line to enforce current limits. The disconnects 824-A and 824-B may be FETs, relays, etc.

The controller 828 may be a microprocessor, microcontroller, DSP, or other digital logic device (with fixed or programmable digital logic gates) configured to perform the fault detection and alerting techniques described herein. The controller 828 may be configured to modulate at least one of the disconnects 824-A and 824-B by disconnecting the further power reception stages at the required interval to force a known current draw (likely near zero or some higher level of current to avoid edge of detection range sensitivity issues). This demonstrates to the power transmitter that no faults are present on the lines 812-A and 812-B and the power receiver is up and running. An optional load equipment ground conductor may be provided if grounding of the load is required/desirable.

Again, one task of the controller 828 is to drive the at least one of disconnects 824-A and 824-B to disconnect from at least one of the lines 812-A and 812-B, respectively, to demonstrate safety at the required interval. The current sense circuits 826-A and 826-B may be employed to provide telemetry, and also to provide current measurement to the controller 828 if the load pulls too much current because of a short-circuit, etc.

In one embodiment, an additional DSP 829 may be provided to demodulate the modulated power waveform to recover the multi-drop signaling waveform on the lines 812-A and 812-B for use in the techniques depicted in FIGS. 1, 2A, 2B, 3, 4 and 5, to determine when to draw power from the modulated power waveform received on the lines 812-A and 812-B. Alternatively, the controller 828 may be configured to demodulate the modulated power waveform, recover the multi-drop signaling waveform, and evaluate the multi-drop signaling waveform to determine when to draw power from the modulated power waveform received on the lines 812-A and 812-B.

FIG. 8C shows a power delivery system that includes a power transmitter 830 and a power receiver 840 according to still another fault managed power variation. The power transmitter 830 includes a voltage source (AC or DC) 831 and a digital fuse 832 that controls disconnects 834-A and 834-B coupled to the send wire 836-A and receive wire 836-B, respectively. The digital fuse 832 may include one (or more) DSPs 833. Similarly, the power receiver 840 includes a digital fuse 842 that controls disconnects 844-A and 844-B also coupled to the send wire 836-A and return wire 836-B, respectively, and provides received power to a load 846 (after isolation and other possible intervening circuits, if required). The digital fuse 842 includes one (or more) DSPs 843. At a high-level, the digital fuses 832 and 842 inject pulses (called “chirp pulses”) onto the wires 836-A and 836-B and analyze signals on the wires to detect whether there is an impedance-based fault on either the send wire 836-A or receive wire 836-B. The digital fuse may be used for situations where power is continuously applied over a wire as well as to situations in which power is provided in pulses separated by off intervals that can be used to perform fault detections. Moreover, the DSP 833 of the power transmitter 830 may be configured to generate the multi-drop signaling waveform and to modulate a power waveform with the multi-drop signaling waveform to produce the modulated power waveform provided over wires 836-A and 836-B. Similarly, the DSP 843 of the power receiver 840 may be configured to demodulated the modulated power waveform, extract and evaluate the multi-drop signaling waveform to determine when to draw power from the modulated power waveform received over the wires 836-A and 836-B.

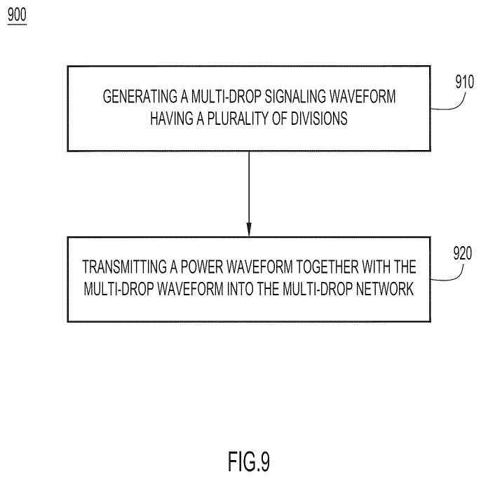

Reference is now made to FIG. 9 for a description of a method 900 performed by a power transmitter according to the techniques presented herein. The method 900 includes, at step 910, generating a multi-drop signaling waveform having a plurality of divisions. One or more divisions of the plurality of divisions are assigned to a corresponding drop of a plurality of drops in a multi-drop power delivery arrangement. At step 920, the method 900 includes transmitting a power waveform together with the multi-drop signaling waveform into the multi-drop power delivery arrangement. By transmitting the power waveform together with the multi-drop signaling waveform, a power receiver at each drop of the plurality of drops can draw an associated portion of power from the power waveform based on assignment of one or more divisions to a respective drop of the plurality of drops. As described above in connection with FIGS. 2A, 2B and 3, the step of transmitting may include superimposing the multi-drop signaling waveform on the power waveform.

In one example as described above in connection with FIGS. 2A and 2B, the power waveform is a DC power waveform. Moreover, the multi-drop signaling waveform may be a multi-frequency waveform comprising a plurality of frequencies each of which extends for a corresponding time period, and wherein the plurality of divisions are the plurality of frequencies of the multi-frequency waveform.

In another example as described above in connection with FIG. 3, the power waveform is an AC power waveform. Further, the multi-drop signaling waveform may be a waveform of a predetermined frequency, and each cycle of a plurality of cycles of the waveform is a division of the plurality of divisions (of the multi-drop signaling waveform) that are in turn associated with one of a plurality of phase divisions of the power waveform, and each drop of the plurality of drops is assigned to one or more cycles of the plurality of cycles of the waveform.

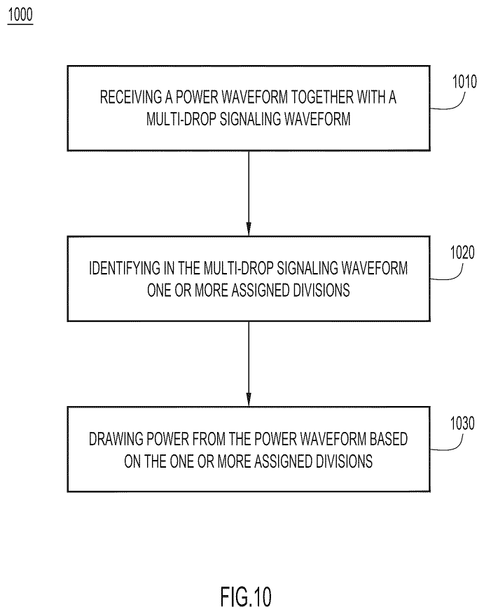

FIG. 10 illustrates a flow chart depicting a method 1000 performed by a power receiver at a drop of a plurality of drops in a multi-drop power delivery arrangement, in accordance with the techniques presented herein. The method 1000 includes, at step 1010, receiving a power waveform together with a multi-drop signaling waveform. At step 1020, the method 1000 involves identifying in the multi-drop signaling waveform one or more assigned divisions to the drop. At step 1030, the method 1000 includes drawing power from the power waveform based on the one or more assigned divisions for the drop.

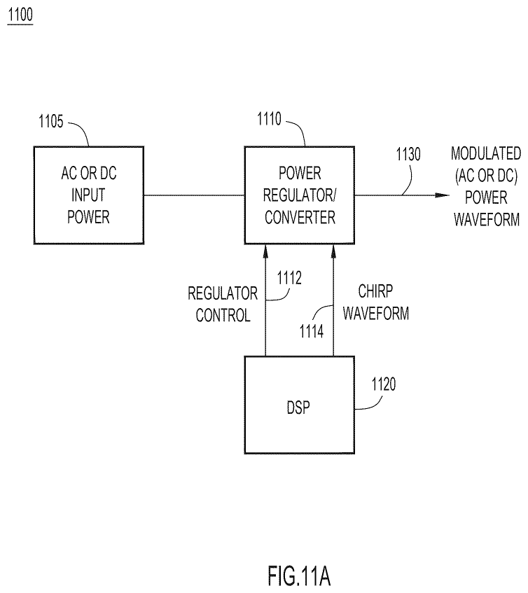

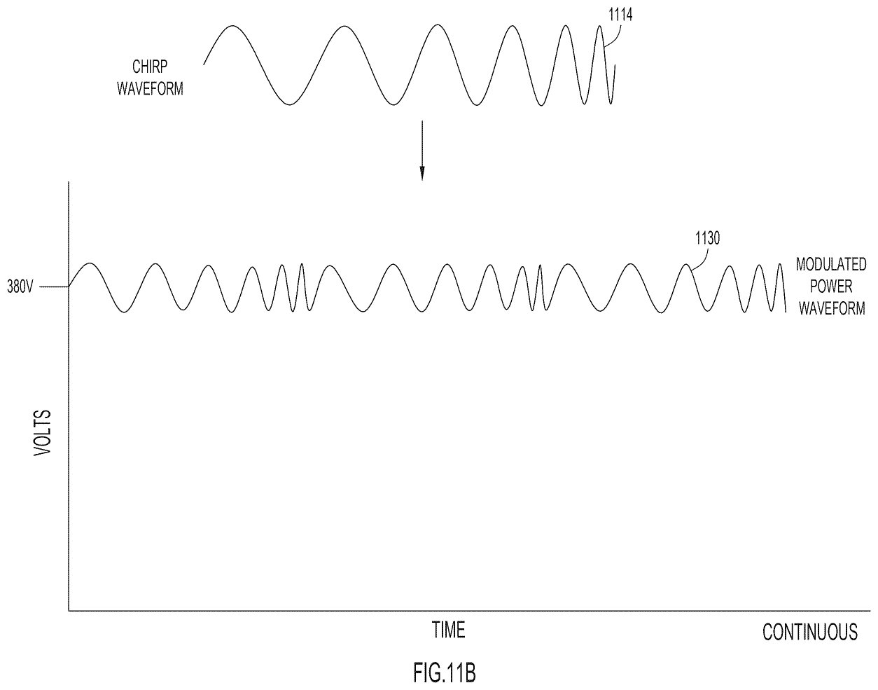

Reference is now made to FIG. 11A. This figure shows a block diagram of a power transmitter 1100 to modulate a power waveform to produce a modulated power waveform, according to an example embodiment. This may be useful in the embodiments described above (for modulating a multi-drop signaling waveform on a power waveform) in connection with FIGS. 1, 2A, 2B, 3-7, 8A, 8B, 8C, 9 and 10. The power transmitter 1100 includes an AC or DC input power supply 1105, a power regulator/converter 1110, and a DSP 1120. In one example, the AC or DC input power supply 1105 provides 400 VDC power. The power regulator/converter 1110 performs DC-DC isolation and regulation, and receives as input a regulator control 1112 and a chirp waveform 1114. The DSP 1120 may provide the chirp waveform 1114 (according to the arrangement described above in connection with FIGS. 8A and 8C, for example, and may also provide the regulator control 1112. Alternatively, the regulator control 1112 may be provided by a switch mode regulator and FET switch control circuit. In either case, the power regulator/converter 1110 uses the regulator control 1112 and chirp waveform 1114 to modulate a power waveform provided to by the AC or DC input power supply 1105 to generate as output a modulated (AC or DC) power waveform 1130.

FIG. 11B shows an example of a chirp waveform 1114 and a modulated power waveform 1130 derived from the chirp waveform 1114. The chirp waveform 1114 comprises a series of different frequency pulses, for example. When the chirp waveform 1114 is modulated onto a (raw) power waveform, the modulated power waveform 1130 is produced.

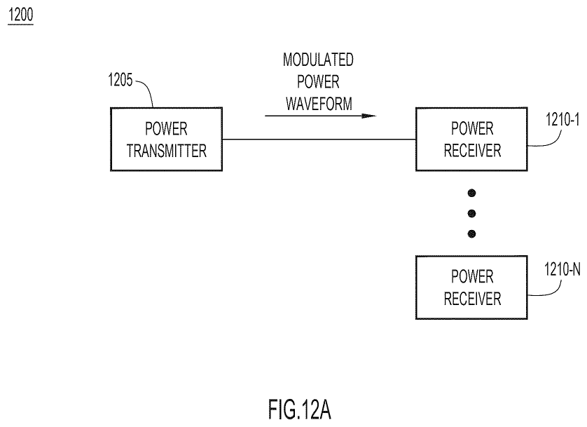

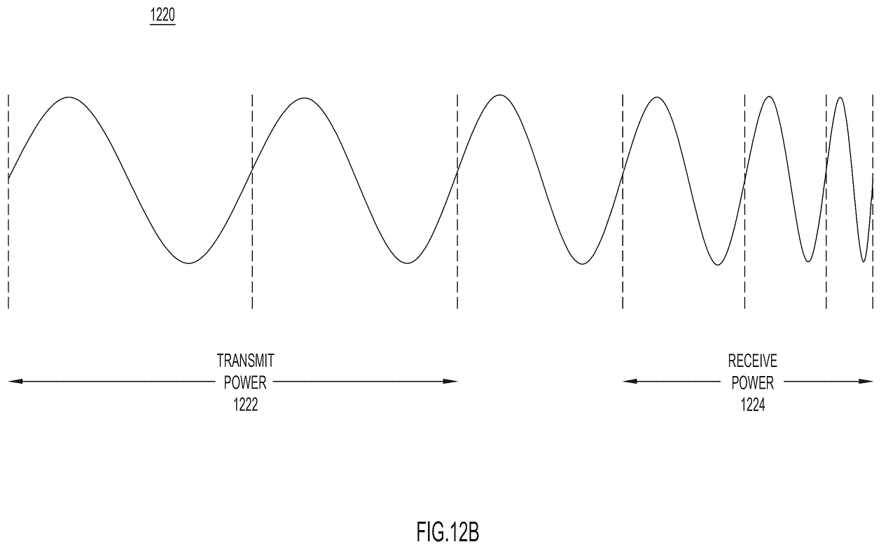

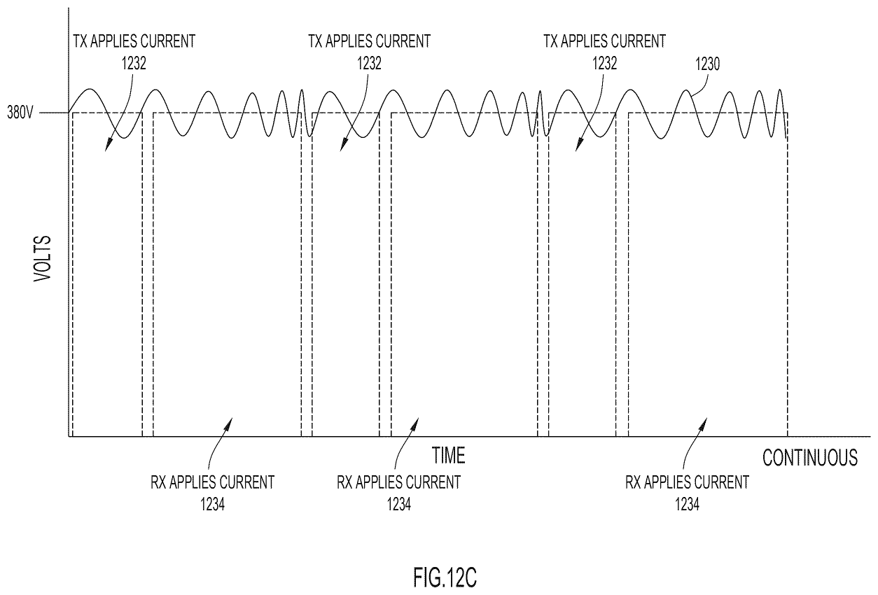

Reference is now made to FIG. 12A, which shows a block diagram of a system 1200 that employs a modulated power waveform according to the techniques presented here. The system 1200 includes a power transmitter 1205 and one or several power receivers 1210-1 to 1210-N in a multi-drop arrangement. The power transmitter 1205 and power receiver(s) 1210-1 to 1210-N may negotiate whether (1) the power transmitter supplies all power continuously, or (2) the power transmitter (or more generally a “first device”) transmits power at a certain frequency(ies) of the modulated power waveform, and the power receiver(s) (more generally a “second device”) transmits power at other frequency(ies) of the modulated power waveform. In other words, the modulated power waveform techniques can be used for bi-directional power transfer without the power receiver and the power transmitter exchanging “roles”. For example, as shown in FIG. 12B, a chirp waveform 1220 is shown where two frequencies, shown at 1222, are used for the power transmitter 1205 to transmit power, and the remaining other frequencies, shown at 1224, are used for a power receiver, e.g., power receiver 1210-1, to transmit power to the power transmitter 1205 and thus be received by the power transmitter 1205. FIG. 12C illustrates another scheme for a modulated power waveform 1230, in which as shown at 1232, for a certain time interval corresponding to a certain frequency of the modulated power waveform 1230, the power transmitter 1205 applies current, and as shown at 1234, for a certain time interval corresponding to other frequencies of the modulated power waveform 1230, the power receiver 1210-1 applies current. FIG. 12C shows a role switching between devices on opposite ends of a cable in terms of which device is transmitting power (where power is V*I) to the other device during certain portions (corresponding to frequencies of a chirp waveform) of a modulated power waveform. In the example of FIG. 12C, the power transmitter 1205 maintains the voltage and the power receiver 1210 dumps current.

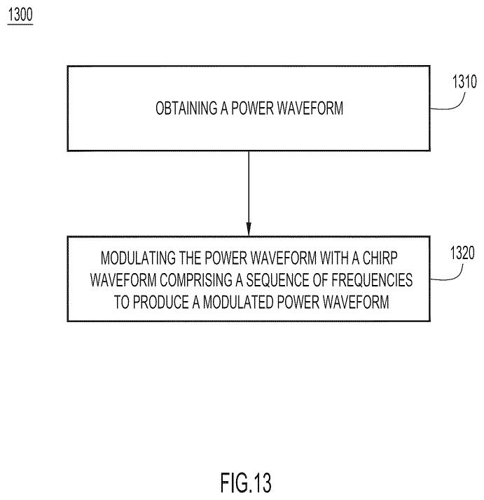

Turning now to FIG. 13, a flow chart is shown depicting a method 1300 according to an example embodiment. The method 1300 may include, at step 1310, obtaining a power waveform (e.g., an AC or DC power waveform obtained from a AC or DC power supply). At step 1320, a first device modulates the power waveform with a chirp waveform comprising a sequence of frequencies to produce a modulated power waveform for transmission over a cable to a second device.

As described above in connection with FIGS. 12A-12C, the modulating step 1310 may involve modulating at the first device the power waveform with the chirp waveform for transmitting power during a first one or more frequencies of the chirp waveform from the first device to the second device, and modulating at the second device the power waveform with the chirp waveform for transmitting power from the second device to the first device during a second one or more frequencies of the chirp waveform.

Moreover, the method 1300 may further include negotiating between the first device and the second device to determine assignment of respective frequencies of the chirp waveform to be used for transmitting power from the first device to the second device, and for transmitting power from the second device to the first device.

The power waveform modulation techniques depicted in FIGS. 11A, 11B and 12A-12C may be used to enable, and/or in combination with, techniques described above in connection with 1, 2A, 2B, 3-7 and 8A-8C.

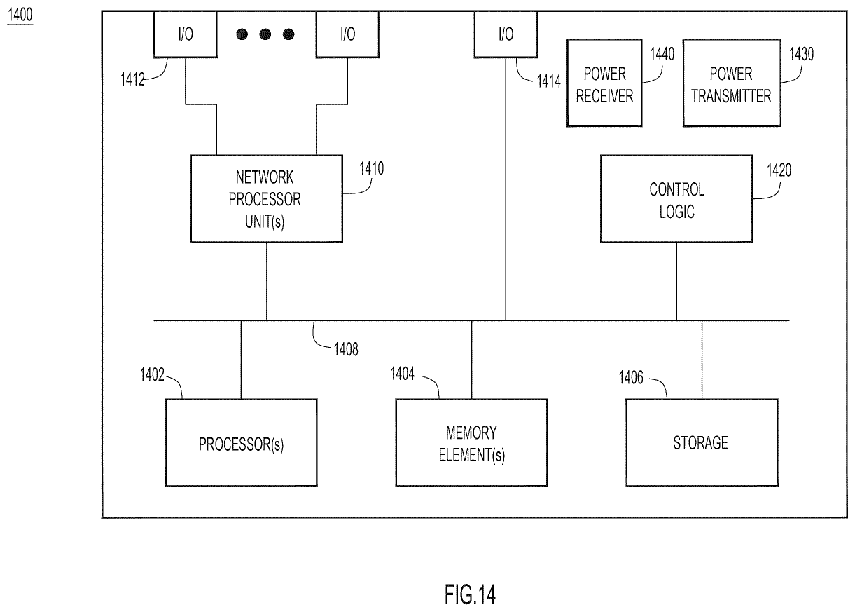

Referring to FIG. 14, FIG. 14 illustrates a hardware block diagram of a device 1400 that may perform functions associated with operations discussed herein in connection with the techniques depicted in FIGS. 1, 2A, 2B, 3-7, 8A-8C, and 9-13. In various embodiments, a computing or networking device or apparatus, such as device 1400 or any combination of devices 1400, may be configured as any entity/entities as discussed for the techniques depicted in connection with FIGS. 1, 2A, 2B, 3-7, 8A-8C, and 9-13 in order to perform operations of the various techniques discussed herein.

In at least one embodiment, the device 1400 may be any apparatus that may include one or more processor(s) 1402, one or more memory element(s) 1404, storage 1406, a bus 1408, one or more network processor unit(s) 1410 interconnected with one or more network input/output (I/O) interface(s) 1412, one or more I/O interface(s) 1414, and control logic 1420. In various embodiments, instructions associated with logic for device 1400 can overlap in any manner and are not limited to the specific allocation of instructions and/or operations described herein. The device 1400 may further include a power transmitter 1430 configured to perform the power transmitter side operations described herein and/or a power receiver 1440 configured to perform the power receiver side operations described herein.

In at least one embodiment, processor(s) 1402 is/are at least one hardware processor configured to execute various tasks, operations and/or functions for device 1400 as described herein according to software and/or instructions configured for device 1400. Processor(s) 1402 (e.g., a hardware processor) can execute any type of instructions associated with data to achieve the operations detailed herein. In one example, processor(s) 1402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1404 and/or storage 1406 is/are configured to store data, information, software, and/or instructions associated with device 1400, and/or logic configured for memory element(s) 1404 and/or storage 1406. For example, any logic described herein (e.g., control logic 1420) can, in various embodiments, be stored for device 1400 using any combination of memory element(s) 1404 and/or storage 1406. Note that in some embodiments, storage 1406 can be consolidated with memory element(s) 1404 (or vice versa), or can overlap/exist in any other suitable manner.

In at least one embodiment, bus 1408 can be configured as an interface that enables one or more elements of device 1400 to communicate in order to exchange information and/or data. Bus 1408 can be implemented with any architecture designed for passing control, data and/or information between processors, memory elements/storage, peripheral devices, and/or any other hardware and/or software components that may be configured for device 1400. In at least one embodiment, bus 1408 may be implemented as a fast kernel-hosted interconnect, potentially using shared memory between processes (e.g., logic), which can enable efficient communication paths between the processes.

In various embodiments, network processor unit(s) 1410 may enable communication between device 1400 and other systems, entities, etc., via network I/O interface(s) 1412 (wired and/or wireless) to facilitate operations discussed for various embodiments described herein. In various embodiments, network processor unit(s) 1410 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 1400 and other systems, entities, etc. to facilitate operations for various embodiments described herein. In various embodiments, network I/O interface(s) 1412 can be configured as one or more Ethernet port(s), Fibre Channel ports, any other I/O port(s), and/or antenna(s)/antenna array(s) now known or hereafter developed. Thus, the network processor unit(s) 1410 and/or network I/O interface(s) 1412 may include suitable interfaces for receiving, transmitting, and/or otherwise communicating data and/or information in a network environment.

I/O interface(s) 1414 allow for input and output of data and/or information with other entities that may be connected to device 1400. For example, I/O interface(s) 1414 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1420 can include instructions that, when executed, cause processor(s) 1402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1404 and/or storage 1406 can store data, software, code, instructions (e.g., processor instructions), logic, parameters, combinations thereof, and/or the like used for operations described herein. This includes memory element(s) 1404 and/or storage 1406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method performed by a power transmitter, including: generating a multi-drop signaling waveform having a plurality of divisions, one or more divisions of the plurality of divisions being assigned to a corresponding drop of a plurality of drops in a multi-drop power delivery arrangement; and transmitting a power waveform together with the multi-drop signaling waveform into the multi-drop power delivery arrangement such that a power receiver at each drop of the plurality of drops draws an associated portion of power from the power waveform based on assignment of one or more divisions to a respective drop of the plurality of drops.

In some aspects, the techniques described herein relate to a method, wherein transmitting includes superimposing or modulating the multi-drop signaling waveform on the power waveform to produce a modulated power waveform that is transmitted into the multi-drop power delivery arrangement.

In some aspects, the techniques described herein relate to a method, wherein the power waveform is a direct current (DC) power waveform.

In some aspects, the techniques described herein relate to a method, wherein the multi-drop signaling waveform is a multi-frequency waveform including a plurality of frequencies each of which extends for a corresponding time period, and the plurality of divisions are the plurality of frequencies of the multi-frequency waveform.

In some aspects, the techniques described herein relate to a method, wherein the power waveform is an alternating current (AC) power waveform.

In some aspects, the techniques described herein relate to a method, wherein the multi-drop signaling waveform includes a waveform of a predetermined frequency, and each cycle of a plurality of cycles of the waveform is a division of the plurality of divisions and are associated with one of a plurality of phase divisions of the power waveform, and each drop of the plurality of drops being assigned to one or more cycles of the plurality of cycles of the waveform.

In some aspects, the techniques described herein relate to a method, further including: at a drop of the plurality of drops, receiving the modulated power waveform and demodulating the modulated power waveform to recover the multi-drop signaling waveform; identifying in the multi-drop signaling waveform one or more assigned divisions to the drop; and based on the identifying, drawing power from the power waveform based on the one or more assigned divisions for the drop.

In some aspects, the techniques described herein relate to a method, wherein drawing includes drawing power from the power waveform during a time period corresponding to a next subsequent division of the multi-drop signaling waveform.

In some aspects, the techniques described herein relate to a method, wherein the multi-drop signaling waveform is a multi-frequency waveform including a plurality of frequencies each of which extends for a corresponding time period, and the plurality of divisions are the plurality of frequencies of the multi-frequency waveform, and wherein drawing includes drawing power from the power waveform during a time period for a next subsequent frequency to a frequency of the multi-frequency waveform to which the drop is assigned.

In some aspects, the techniques described herein relate to a method, wherein the multi-drop signaling waveform includes a waveform of a predetermined frequency, and each cycle of a plurality of cycles of the waveform is a division of the plurality of divisions and is associated with one of a plurality of phase divisions of the power waveform, and each drop of the plurality of drops being assigned to one or more cycles of the plurality of cycles of the waveform, and wherein drawing power includes drawing power from the power waveform during a time period corresponding to a next subsequent cycle of the plurality of cycles of the waveform to a cycle to which the drop is assigned.

In some aspects, the techniques described herein relate to a method, wherein a corresponding time period for each of the plurality of divisions of the multi-drop signaling waveform is associated with a corresponding percentage allocation of power of the power waveform.

In some aspects, the techniques described herein relate to a method, further including: negotiating between the power transmitter and a power receiver at each of the plurality of drops to determine assignment of respective divisions of the plurality of divisions to each of the plurality of drops.

In some aspects, the techniques described herein relate to a method performed by a power receiver, including: at a drop of a plurality of drops in a multi-drop power delivery arrangement, receiving a power waveform together with a multi-drop signaling waveform having a plurality of divisions; identifying one or more assigned divisions to the drop in the multi-drop signaling waveform; and based on the identifying, drawing power from the power waveform for the one or more assigned divisions for the drop.

In some aspects, the techniques described herein relate to a method, wherein drawing includes drawing power from the power waveform during a time period corresponding to a next subsequent division of the multi-drop signaling waveform.

In some aspects, the techniques described herein relate to a method, wherein the multi-drop signaling waveform is a multi-frequency waveform including a plurality of frequencies each of which extends for a corresponding time period, and the plurality of divisions are the plurality of frequencies of the multi-frequency waveform, and wherein drawing includes drawing power from the power waveform during a time period for a next subsequent frequency to a frequency of the multi-frequency waveform to which the drop is assigned.

In some aspects, the techniques described herein relate to a method, wherein the multi-drop signaling waveform includes a waveform of a predetermined frequency, and each cycle of a plurality of cycles of the waveform is a division of the plurality of divisions and is associated with one of a plurality of phase divisions of the power waveform, and each drop of the plurality of drops being assigned to one or more cycles of the plurality of cycles of the waveform, and wherein drawing power includes drawing power from the power waveform during a time period corresponding to a next subsequent cycle of the plurality of cycles of the waveform to a cycle to which the drop is assigned.

In some aspects, the techniques described herein relate to a method including: obtaining a power waveform; and at a first device, modulating the power waveform with a chirp waveform including a sequence of frequencies to produce a modulated power waveform for transmission over a cable to a second device.

In some aspects, the techniques described herein relate to a method, wherein the modulating includes modulating at the first device the power waveform with the chirp waveform for transmitting power during a first one or more frequencies of the chirp waveform from the first device to the second device, and modulating at the second device the power waveform with the chirp waveform for transmitting power from the second device to the first device during a second one or more frequencies of the chirp waveform.

In some aspects, the techniques described herein relate to a method, wherein the power waveform is a direct current (DC) power waveform or an alternating current (AC) power waveform.

In some aspects, the techniques described herein relate to a method, further including: negotiating between the first device and the second device to determine assignment of respective frequencies of the chirp waveform to be used for transmitting power from the first device to the second device, and for transmitting power from the second device to the first device.

In some aspects, the techniques described herein relate to a system including: a plurality of power receivers at a corresponding drop of a plurality of drops in multi-drop arrangement; and a power transmitter configured to configured to: generate a multi-drop signaling waveform having a plurality of divisions, one or more divisions of the plurality of divisions to be assigned to a corresponding drop of the plurality of drops; and superimpose or modulate the multi-drop signaling waveform onto a power waveform to produce a modulated power waveform for transmission into the multi-drop arrangement such that the power receiver at each drop draws an associated portion of power from the power waveform based on assignment of one or more divisions to a respective drop of the plurality of drops.

In some aspects, the techniques described herein relate to a system, wherein the power waveform is a direct current (DC) power waveform, and the multi-drop signaling waveform is a multi-frequency waveform including a plurality of frequencies each of which extends for a corresponding time period, and the plurality of divisions are the plurality of frequencies of the multi-frequency waveform.

In some aspects, the techniques described herein relate to a system, wherein the power waveform is an alternating current (AC) power waveform, and the multi-drop signaling waveform includes a waveform of a predetermined frequency, and each cycle of a plurality of cycles of the waveform is a division of the plurality of divisions and are associated with one of a plurality of phase divisions of the power waveform, and each drop of the plurality of drops being assigned to one or more cycles of the plurality of cycles of the waveform.

In some aspects, the techniques described herein relate to a system, wherein each power receiver of the plurality of power receivers at a respective drop of the plurality of drops is configured to: receive the modulated power waveform; demodulate the modulated power waveform to recover the multi-drop signaling waveform; and identify in the multi-drop signaling waveform one or more assigned divisions to the drop; and draw power from the power waveform based on the one or more assigned divisions for the drop.

In some aspects, the techniques described herein relate to a system, wherein each power receiver of the plurality of power receivers draws power from the power waveform during a time period corresponding to a next subsequent division of the multi-drop signaling waveform.

In some aspects, the techniques described herein relate to a system, wherein a corresponding time period for each of the plurality of divisions of the multi-drop signaling waveform is associated with a corresponding percentage allocation of power of the power waveform.

In some aspects, the techniques described herein relate to a system, wherein the power transmitter and each power receiver of the plurality of power receivers negotiate assignment of respective divisions of the plurality of divisions to each of the plurality of drops.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method performed by a power transmitter, comprising:
generating a multi-drop signaling waveform having a plurality of divisions, one or more divisions of the plurality of divisions being assigned to a corresponding drop of a plurality of drops in a multi-drop power delivery arrangement; and
transmitting a power waveform together with the multi-drop signaling waveform into the multi-drop power delivery arrangement such that a power receiver at each drop of the plurality of drops draws an associated portion of power from the power waveform based on assignment of one or more divisions to a respective drop of the plurality of drops.

2. The method of claim 1, wherein transmitting includes superimposing or modulating the multi-drop signaling waveform on the power waveform to produce a modulated power waveform that is transmitted into the multi-drop power delivery arrangement.

3. The method of claim 2, wherein the power waveform is a direct current (DC) power waveform.

4. The method of claim 3, wherein the multi-drop signaling waveform is a multi-frequency waveform comprising a plurality of frequencies each of which extends for a corresponding time period, and the plurality of divisions are the plurality of frequencies of the multi-frequency waveform.

5. The method of claim 2, wherein the power waveform is an alternating current (AC) power waveform.

6. The method of claim 5, wherein the multi-drop signaling waveform comprises a waveform of a predetermined frequency, and each cycle of a plurality of cycles of the waveform is a division of the plurality of divisions and are associated with one of a plurality of phase divisions of the power waveform, and each drop of the plurality of drops being assigned to one or more cycles of the plurality of cycles of the waveform.

7. The method of claim 2, further comprising:
at a drop of the plurality of drops, receiving the modulated power waveform and demodulating the modulated power waveform to recover the multi-drop signaling waveform;
identifying in the multi-drop signaling waveform one or more assigned divisions to the drop; and
based on the identifying, drawing power from the power waveform based on the one or more assigned divisions for the drop.

8. The method of claim 7, wherein drawing comprises drawing power from the power waveform during a time period corresponding to a next subsequent division of the multi-drop signaling waveform.

9. The method of claim 8, wherein the multi-drop signaling waveform is a multi-frequency waveform comprising a plurality of frequencies each of which extends for a corresponding time period, and the plurality of divisions are the plurality of frequencies of the multi-frequency waveform, and wherein drawing comprises drawing power from the power waveform during a time period for a next subsequent frequency to a frequency of the multi-frequency waveform to which the drop is assigned.

10. The method of claim 8, wherein the multi-drop signaling waveform comprises a waveform of a predetermined frequency, and each cycle of a plurality of cycles of the waveform is a division of the plurality of divisions and is associated with one of a plurality of phase divisions of the power waveform, and each drop of the plurality of drops being assigned to one or more cycles of the plurality of cycles of the waveform, and wherein drawing power comprises drawing power from the power waveform during a time period corresponding to a next subsequent cycle of the plurality of cycles of the waveform to a cycle to which the drop is assigned.

11. The method of claim 1, wherein a corresponding time period for each of the plurality of divisions of the multi-drop signaling waveform is associated with a corresponding percentage allocation of power of the power waveform.

12. The method of claim 1, further comprising:
negotiating between the power transmitter and a power receiver at each of the plurality of drops to determine assignment of respective divisions of the plurality of divisions to each of the plurality of drops.

13. A method performed by a power receiver, comprising:
at a drop of a plurality of drops in a multi-drop power delivery arrangement, receiving a power waveform together with a multi-drop signaling waveform having a plurality of divisions;
identifying one or more assigned divisions to the drop in the multi-drop signaling waveform; and
based on the identifying, drawing power from the power waveform for the one or more assigned divisions for the drop.

14. The method of claim 13, wherein drawing comprises drawing power from the power waveform during a time period corresponding to a next subsequent division of the multi-drop signaling waveform.

15. The method of claim 14, wherein the multi-drop signaling waveform is a multi-frequency waveform comprising a plurality of frequencies each of which extends for a corresponding time period, and the plurality of divisions are the plurality of frequencies of the multi-frequency waveform, and wherein drawing comprises drawing power from the power waveform during a time period for a next subsequent frequency to a frequency of the multi-frequency waveform to which the drop is assigned.

16. The method of claim 14, wherein the multi-drop signaling waveform comprises a waveform of a predetermined frequency, and each cycle of a plurality of cycles of the waveform is a division of the plurality of divisions and is associated with one of a plurality of phase divisions of the power waveform, and each drop of the plurality of drops being assigned to one or more cycles of the plurality of cycles of the waveform, and wherein drawing power comprises drawing power from the power waveform during a time period corresponding to a next subsequent cycle of the plurality of cycles of the waveform to a cycle to which the drop is assigned.

17. A method comprising:
obtaining a power waveform; and
at a first device, modulating the power waveform with a chirp waveform comprising a sequence of frequencies to produce a modulated power waveform for transmission over a cable to a second device.

18. The method of claim 17, wherein the modulating comprises modulating at the first device the power waveform with the chirp waveform for transmitting power during a first one or more frequencies of the chirp waveform from the first device to the second device, and modulating at the second device the power waveform with the chirp waveform for transmitting power from the second device to the first device during a second one or more frequencies of the chirp waveform.

19. The method of claim 17, wherein the power waveform is a direct current (DC) power waveform or an alternating current (AC) power waveform.

20. The method of claim 17, further comprising:
negotiating between the first device and the second device to determine assignment of respective frequencies of the chirp waveform to be used for transmitting power from the first device to the second device, and for transmitting power from the second device to the first device.

21. A system comprising:
a plurality of power receivers at a corresponding drop of a plurality of drops in multi-drop arrangement; and
a power transmitter configured to configured to:
generate a multi-drop signaling waveform having a plurality of divisions, one or more divisions of the plurality of divisions to be assigned to a corresponding drop of the plurality of drops; and
superimpose or modulate the multi-drop signaling waveform onto a power waveform to produce a modulated power waveform for transmission into the multi-drop arrangement such that the power receiver at each drop draws an associated portion of power from the power waveform based on assignment of one or more divisions to a respective drop of the plurality of drops.

22. The system of claim 21, wherein the power waveform is a direct current (DC) power waveform, and the multi-drop signaling waveform is a multi-frequency waveform comprising a plurality of frequencies each of which extends for a corresponding time period, and the plurality of divisions are the plurality of frequencies of the multi-frequency waveform.

23. The system of claim 21, wherein the power waveform is an alternating current (AC) power waveform, and the multi-drop signaling waveform comprises a waveform of a predetermined frequency, and each cycle of a plurality of cycles of the waveform is a division of the plurality of divisions and are associated with one of a plurality of phase divisions of the power waveform, and each drop of the plurality of drops being assigned to one or more cycles of the plurality of cycles of the waveform.

24. The system of claim 21, wherein each power receiver of the plurality of power receivers at a respective drop of the plurality of drops is configured to:
receive the modulated power waveform;
demodulate the modulated power waveform to recover the multi-drop signaling waveform;
identify in the multi-drop signaling waveform one or more assigned divisions to the drop; and
draw power from the power waveform based on the one or more assigned divisions for the drop.

25. The system of claim 24, wherein each power receiver of the plurality of power receivers draws power from the power waveform during a time period corresponding to a next subsequent division of the multi-drop signaling waveform.

26. The system of claim 21, wherein a corresponding time period for each of the plurality of divisions of the multi-drop signaling waveform is associated with a corresponding percentage allocation of power of the power waveform.

27. The system of claim 21, wherein the power transmitter and each power receiver of the plurality of power receivers negotiate assignment of respective divisions of the plurality of divisions to each of the plurality of drops.
